(19) United States
(12) Patent Application Publication
(10) Pub. No.: US 2023/0214397 A1
(43) Pub. Date: Jul. 6, 2023

(54) SERVER AND ELECTRONIC DEVICE FOR PROCESSING USER UTTERANCE AND OPERATING METHOD THEREOF

(71) Applicant: SAMSUNG ELECTRONICS CO., LTD., Suwon-si (KR)

(72) Inventors: Sangmin PARK, Suwon-si (KR); Jaeyung YEO, Suwon-si (KR); Gajin SONG, Suwon-si (KR)

(21) Appl. No.: 18/112,658

(22) Filed: Feb. 22, 2023

Related U.S. Application Data
(63) Continuation of application No. PCT/KR2022/018382, filed on Nov. 21, 2022.

(30) Foreign Application Priority Data
Jan. 6, 2022 (KR) 10-2022-0002137
Feb. 14, 2022 (KR) 10-2022-0018648

(51) Int. Cl. G06F 16/2457; G06F 16/21; G06F 16/23

(52) U.S. Cl. CPC G06F 16/2457; G06F 16/219; G06F 16/2358

(57) ABSTRACT

An intelligent server for processing a user utterance may receive a target utterance from an electronic device to process the target utterance using user history information according to a task parameter, determine a task parameter corresponding to the target utterance, the task parameter being a parameter for performing an action according to a user intent, obtain the user history information corresponding to the task parameter, designate a target domain for processing the target utterance according to the user intent based on the user history information, generate a result of processing the target utterance based on the target domain, and transmit the result of processing the target utterance to the electronic device. In addition, various examples may be possible.

### CROSS-REFERENCE TO RELATED APPLICATIONS

This application is a continuation application of International Application No. PCT/KR2022/018382 designating the United States, filed on Nov. 21, 2022, in the Korean Intellectual Property Receiving Office and claims priority to Korean Patent Application No. 10-2022-0002137, filed on Jan. 6, 2022, and Korean Patent Application No. 10-2022-0018648, filed on Feb. 14, 2022, in the Korean Intellectual Property Office, the disclosures of which are hereby incorporated herein by reference herein in their entireties.

### BACKGROUND

### 1. Field

Certain example embodiments relate to an intelligent server and/or an electronic device for processing a user utterance and/or an operating method thereof.

### 2. Description of Related Art

Electronic devices including a voice assistant function that provides a service based on user utterance are being widely distributed. The electronic device may recognize the user utterance through an artificial intelligence server and may figure out the meaning and intent of the user utterance. The artificial intelligence server may infer a user intent by interpreting an utterance of the user, perform tasks according to the inferred intent, and perform tasks according to the user intent expressed through interaction, in a natural language, between the user and the artificial intelligence server.

At the moment an utterance is made, the artificial intelligence server may analyze various pieces of information on a situation related to the utterance to figure out an intent of the utterance.

### SUMMARY

There are now multiple different services, and an increasing number of domains support similar functions. For example, multiple messenger applications that perform similar functions, such as a function of sending or deleting messages, may be installed on a user terminal.

If a user has not designated a domain to perform an action according to an utterance intent, an artificial intelligence server, comprising circuitry, has to ask the user which domain should be used to process the utterance or set a default domain in advance among multiple domains that perform similar functions.

According to an example embodiment, an intelligent server for processing a user utterance may include a communication module, comprising communication circuitry, configured to receive a target utterance from an electronic device and transmit a result of processing the target utterance to the electronic device. The intelligent server may include a user log database (DB) configured to store user history information corresponding to a task parameter, the task parameter being a parameter for performing an action according to a user intent. The intelligent server may include a memory configured to store computer-executable instructions. The intelligent server may include a processor configured to execute the instructions by accessing the memory. The instructions may be configured to determine the task parameter corresponding to the target utterance, obtain the user history information corresponding to the task parameter with reference to the user log DB, designate a target domain for processing the target utterance according to a user intent based on the user history information, and generate the result of processing the target utterance based on the target domain.

According to an example embodiment, a method of processing a user utterance may include receiving a target utterance from an electronic device. The method may include determining a task parameter corresponding to the target utterance, the task parameter being a parameter for performing an action according to a user intent. The method may include obtaining user history information corresponding to the task parameter. The method may include designating a target domain for processing the target utterance according to the user intent based on the user history information. The method may include generating a result of processing the target utterance based on the target domain and transmitting the result of processing the target utterance to the electronic device.

According to an example embodiment, an electronic device for processing a user utterance may include an input/output module, comprising circuitry, configured to receive a target utterance from a user and output a result of processing the target utterance. The electronic device may include a user log DB configured to store user history information corresponding to a task parameter, the task parameter being a parameter for performing an action according to a user intent. The electronic device may include a memory configured to store computer-executable instructions. The electronic device may include a processor configured to execute the instructions by accessing the memory. The instructions may be configured to determine the task parameter corresponding to the target utterance, obtain the user history information corresponding to the task parameter with reference to the user log DB, designate a target domain for processing the target utterance according to a user intent based on the user history information, and generate the result of processing the target utterance based on the target domain.

According to an example embodiment, an intelligent server and an electronic device that designate a target domain for processing a user utterance in consideration of user history information according to a task parameter of the user utterance may be provided.

According to an example embodiment, a user may receive a processing result appropriate for an utterance intent based on history information for each task parameter without designating a domain to process an utterance.

In addition, various effects that may be directly or indirectly ascertained through the present disclosure may be provided.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an electronic device in a network environment according to an example embodiment;

FIG. 2 is a block diagram illustrating an integrated intelligence system according to an example embodiment;

FIG. 3 is a diagram illustrating a user terminal displaying a screen for processing a voice input received through an intelligent app according to an example embodiment;

FIG. 4 is a diagram illustrating a form in which relationship information between concepts and actions is stored in a database according to an example embodiment;

FIG. 5 is a block diagram illustrating an electronic device and an intelligent server according to an example embodiment;

FIGS. 6A, 6B, 7A, 7B, 8, 9A, 9B, 10A, and 10B are diagrams illustrating an operation of an intelligent server to process a user utterance, according to an example embodiment;

FIG. 11 is a flowchart illustrating an operation of an intelligent server to process an utterance, according to an example embodiment;

FIG. 12 is a flowchart illustrating an operation of an intelligent server to process an utterance in response to a plurality of candidate domains being provided, according to an example embodiment; and

FIG. 13 is a block diagram illustrating an operation of an electronic device on which on-device artificial intelligence (AI) is mounted, according to an example embodiment.

### DETAILED DESCRIPTION

Hereinafter, embodiments will be described in detail with reference to the accompanying drawings. When describing the embodiments with reference to the accompanying drawings, like reference numerals refer to like elements and a repeated description related thereto will be omitted.

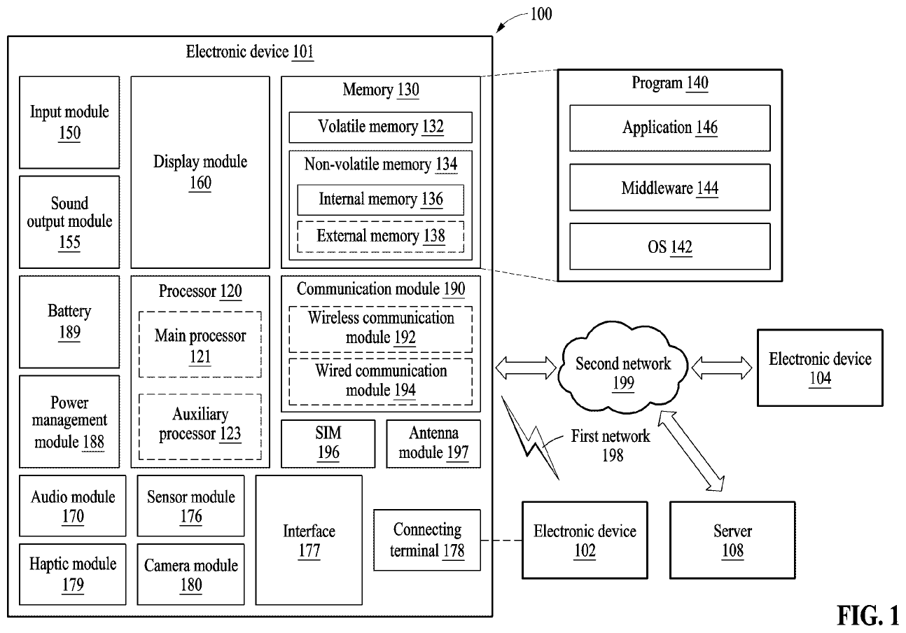

FIG. 1 is a block diagram illustrating an electronic device 101 in a network environment 100 according to an example embodiment.

Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an example embodiment, the electronic device 101 may communicate with the electronic device 104 via the server 108. According to an example embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190 (comprising communication circuitry), a subscriber identification module (SIM) 196, or an antenna module 197. In some embodiments, at least one (e.g., the connecting terminal 178) of the components may be omitted from the electronic device 101, or one or more other components may be added in the electronic device 101. In some embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected, directly or indirectly, to the processor 120, and may perform various data processing or computation. According to an example embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an example embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160 comprising a display, the sensor module 176 comprising at least one sensor, or the communication module 190 comprising communication circuitry) of the components of the electronic device 101, instead of the main processor 121 while the main processor 121 is in an inactive (e.g., sleep) state or along with the main processor 121 while the main processor 121 is an active state (e.g., executing an application). According to an example embodiment, the auxiliary processor 123 (e.g., an ISP or a CP) may be implemented as a portion of another component (e.g., the camera module 180 or the communication module 190) that is functionally related to the auxiliary processor 123. According to an example embodiment, the auxiliary processor 123 (e.g., an NPU) may include a hardware structure specified for artificial intelligence (AI) model processing. An AI model may be generated by machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but examples of which are not limited thereto. The AI model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside the electronic device 101. The sound output module 155 may include, for example, a speaker or a receiver. The speaker may be used for general purposes, such as playing multimedia or playing a recording. The receiver may be used to receive an incoming call. According to an example embodiment, the receiver may be implemented separately from the speaker or as a part of the speaker.

The display module 160 may visually provide information to the outside (e.g., a user) of the electronic device 101. The display module 160 may include, for example, a control circuit for controlling a display, a hologram device, or a projector and control circuitry to control a corresponding one of the display, the hologram device, and the projector. According to an example embodiment, the display module 160 may include a touch sensor adapted to sense a touch, or a pressure sensor adapted to measure an intensity of a force incurred by the touch.

The audio module 170 may convert a sound into an electric signal or vice versa. According to an example embodiment, the audio module 170 may obtain the sound via the input module 150 or output the sound via the sound output module 155 or an external electronic device (e.g., an electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an example embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, a Hall sensor, or an illuminance sensor.

The interface 177 may support one or more specified protocols to be used for the electronic device 101 to be coupled with the external electronic device (e.g., the electronic device 102) directly (e.g., by wire) or wirelessly. According to an example embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an example embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. According to an example embodiment, the haptic module 179 may include, for example, a motor, a piezoelectric element, or an electric stimulator.

The camera module 180 may capture a still image and moving images. According to an example embodiment, the camera module 180 may include one or more lenses, image sensors, ISPs, or flashes.

The power management module 188 may manage power supplied to the electronic device 101. According to an example embodiment, the power management module 188 may be implemented as, for example, at least a part of a power management integrated circuit (PMIC).

The battery 189 may supply power to at least one component of the electronic device 101. According to an example embodiment, the battery 189 may include, for example, a primary cell which is not rechargeable, a secondary cell which is rechargeable, or a fuel cell.

The communication module 190, comprising communication circuitry, may support establishing a direct (e.g., wired) communication channel or a wireless communication channel between the electronic device 101 and the external electronic device (e.g., the electronic device 102, the electronic device 104, or the server 108) and performing communication via the established communication channel The communication module 190 may include one or more CPs that are operable independently of the processor 120 (e.g., an AP) and that support a direct (e.g., wired) communication or a wireless communication. According to an example embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multi components (e.g., multi chips) separate from each other. The wireless communication module 192, comprising communication circuitry, may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an example embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an example embodiment, the antenna module 197 may include an antenna including a radiating element including a conductive material or a conductive pattern formed in or on a substrate (e.g., a printed circuit board (PCB)). According to an example embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an example embodiment, another component (e.g., a radio frequency integrated circuit (RFIC)) other than the radiating element may be additionally formed as a part of the antenna module 197.

According to an example embodiment, the antenna module 197 may form a mmWave antenna module. According to an example embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an example embodiment, all or some of operations to be executed by the electronic device 101 may be executed at one or more external electronic devices (e.g., the external electronic devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra low-latency services using, e.g., distributed computing or MEC. In an example embodiment, the external electronic device 104 may include an Internet-of-things (IoT) device. The server 108 may be an intelligent server using machine learning and/or a neural network. According to an example embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

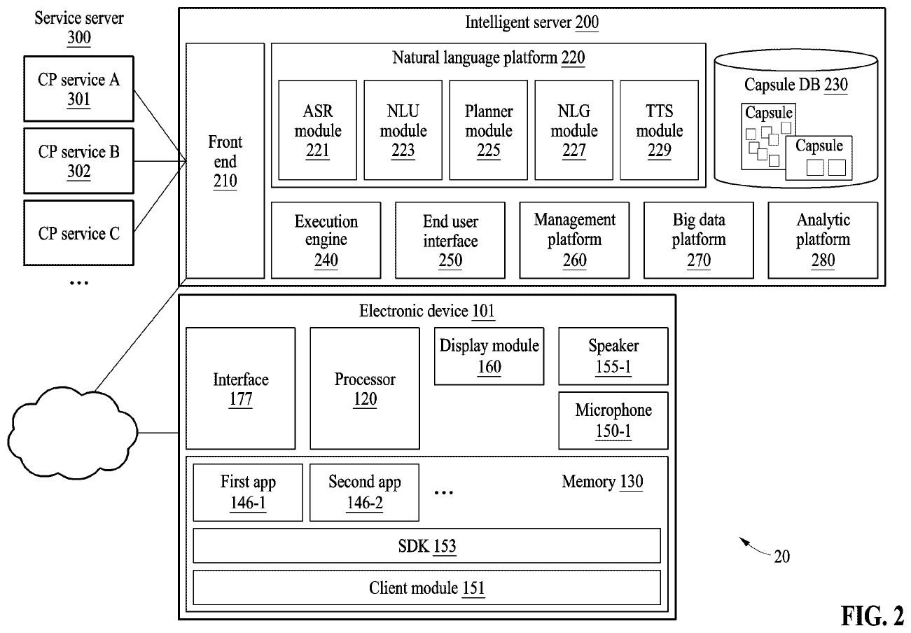

FIG. 2 is a block diagram illustrating an integrated intelligence system according to an example embodiment.

Referring to FIG. 2, an integrated intelligence system 20 may include an electronic device 101, an intelligent server 200, and a service server 300.

The electronic device 101 may be a terminal device (or an electronic device) connectable to the Internet, and may be, for example, a mobile phone, a smartphone, a personal digital assistant (PDA), a notebook computer, a TV, a white home appliance, a wearable device, a head-mounted display (HMD), or a smart speaker.

According to the illustrated example embodiment, the electronic device 101 may include an interface 177, a microphone 150-1, a speaker 155-1, a display module 160, a memory 130, or a processor 120. The components listed above may be operationally or electrically connected, directly or indirectly, to each other. The microphone 150-1 may be included in an input module (e.g., the input module 150 of FIG. 1). The speaker 155-1 may be included in a sound output module (e.g., the sound output module 155 of FIG. 1).

The interface 177 may be connected, directly or indirectly, to an external device and configured to transmit and receive data to and from the external device. The microphone 150-1 may receive a sound (e.g., a user utterance) and convert the sound into an electrical signal. The speaker 155-1 may output the electrical signal as a sound (e.g., a speech). The display module 160 may be configured to display an image or video. The display module 160 may also display a graphical user interface (GUI) of an app (or an application program) being executed.

The memory 130 may store a client module 151, a software development kit (SDK) 153, and a plurality of apps 146. The client module 151 and the SDK 153 may configure a framework (or a solution program) for performing general-purpose functions. In addition, the client module 151 or the SDK 153 may configure a framework for processing a voice input.

The plurality of apps 146 stored in the memory 130 may be programs for performing designated functions. The plurality of apps 146 may include a first app 146-1 and a second app 146-2. Each of the plurality of apps 146 may include a plurality of actions for performing a designated function. For example, the apps may include an alarm app, a messaging app, and/or a scheduling app. The plurality of apps 146 may be executed by the processor 120 to sequentially execute at least a portion of the plurality of actions.

The processor 120 may control the overall operation of the electronic device 101. For example, the processor 120 may be electrically connected, directly or indirectly, to the interface 177, the microphone 150-1, the speaker 155-1, and the display module 160 to perform a designated operation.

The processor 120 may also perform the designated function by executing the program stored in the memory 130. For example, the processor 120 may execute at least one of the client module 151 or the SDK 153 to perform the following operation for processing a voice input. The processor 120 may control the operation of the plurality of apps 146 through, for example, the SDK 153. The following operation which is the operation of the client module 151 or the SDK 153 may be performed by the processor 120.

The client module 151 may receive a voice input. For example, the client module 151 may receive a voice signal corresponding to a user utterance sensed through the microphone 150-1. The client module 151 may transmit the received voice input to the intelligent server 200. The client module 151 may transmit state information of the electronic device 101 together with the received voice input to the intelligent server 200. The state information may be, for example, execution state information of an app.

The client module 151 may receive a result corresponding to the received voice input. For example, when the intelligent server 200 is capable of calculating a result corresponding to the received voice input, the client module 151 may receive the result corresponding to the received voice input. The client module 151 may display the received result on the display module 160.

The client module 151 may receive a plan corresponding to the received voice input. The client module 151 may display results of executing a plurality of actions of an app according to the plan on the display module 160. The client module 151 may, for example, sequentially display the results of executing the plurality of actions on the display module 160. As another example, the electronic device 101 may display only a partial result of executing the plurality of actions (e.g., a result of the last action) on the display module 160.

According to an example embodiment, the client module 151 may receive a request to obtain information necessary for calculating a result corresponding to the voice input from the intelligent server 200. According to an example embodiment, the client module 151 may transmit the necessary information to the intelligent server 200 in response to the request. Each “server” herein, and each “processor” herein, comprises processing circuitry.

The client module 151 may transmit information on the results of executing the plurality of actions according to the plan to the intelligent server 200. The intelligent server 200 may confirm that the received voice input has been correctly processed using the information on the results.

The client module 151 may include a voice recognition module. According to an example embodiment, the client module 151 may recognize a voice input for performing a limited function through the speech recognition module. For example, the client module 151 may execute an intelligent app for processing a voice input to perform an organic operation through a designated input (e.g., Wake up!).

The intelligent server 200 may receive information related to a user voice input from the electronic device 101 through a communication network. According to an example embodiment, the intelligent server 200 may change data related to the received voice input into text data. According to an example embodiment, the intelligent server 200 may generate a plan for performing a task corresponding to the user voice input based on the text data.

According to an example embodiment, the plan may be generated by an artificial intelligence (AI) system. The artificial intelligence system may be a rule-based system or a neural network-based system (e.g., a feedforward neural network (FNN) or a recurrent neural network (RNN)). Alternatively, the artificial intelligence system may be a combination thereof or other artificial intelligence systems. According to an example embodiment, the plan may be selected from a set of predefined plans or may be generated in real time in response to a user request. For example, the AI system may select at least one plan from among the predefined plans.

The intelligent server 200 may transmit a result according to the generated plan to the electronic device 101 or transmit the generated plan to the electronic device 101. According to an example embodiment, the electronic device 101 may display the result according to the plan on the display module 160. According to an example embodiment, the electronic device 101 may display a result of executing an action according to the plan on the display module 160.

The intelligent server 200 may include a front end 210, a natural language platform 220, a capsule database (DB) 230, an execution engine 240, an end user interface 250, a management platform 260, a big data platform 270, or an analytic platform 280.

The front end 210 may receive the received voice input from the electronic device 101. The front end 210 may transmit a response corresponding to the voice input.

According to an example embodiment, the natural language platform 220 may include an automatic speech recognition (ASR) module 221, a natural language understanding (NLU) module 223, a planner module 225, a natural language generator (NLG) module 227, or a text-to-speech (TTS) module 229.

The ASR module 221 may convert the voice input received from the electronic device 101 into text data. The NLU module 223 may discern a user intent using the text data of the voice input. For example, the NLU module 223 may discern the user intent by performing syntactic analysis or semantic analysis. The NLU module 223 may discern the meaning of a word extracted from the voice input using a linguistic feature (e.g., a grammatical element) of a morpheme or phrase, and determine the user intent by matching the discerned meaning of the word to an intent.

The planner module 225 may generate a plan using a parameter and the intent determined by the NLU module 223. According to an example embodiment, the planner module 225 may determine a plurality of domains required to perform a task based on the determined intent. The planner module 225 may determine a plurality of actions included in each of the plurality of domains determined based on the intent. According to an example embodiment, the planner module 225 may determine a parameter required to execute the determined plurality of actions or a result value output by the execution of the plurality of actions. The parameter and the result value may be defined as a concept of a designated form (or class). Accordingly, the plan may include a plurality of actions and a plurality of concepts determined by the user intent. The planner module 225 may determine a relationship between the plurality of actions and the plurality of concepts stepwise (or hierarchically). For example, the planner module 225 may determine an execution order of the plurality of actions determined based on the user intent, based on the plurality of concepts. In other words, the planner module 225 may determine the execution order of the plurality of actions based on the parameter required for the execution of the plurality of actions and results output by the execution of the plurality of actions. Accordingly, the planner module 225 may generate a plan including connection information (e.g., ontology) between the plurality of actions and the plurality of concepts. The planner module 225 may generate the plan using information stored in the capsule DB 230 that stores a set of relationships between concepts and actions.

The NLG module 227 may change designated information into a text form. The information changed to the text form may be in the form of a natural language utterance. The TTS module 229 may change information in a text form into information in a speech form.

According to an example embodiment, some or all of the functions of the natural language platform 220 may be implemented in the electronic device 101 as well.

The capsule DB 230 may store information on the relationship between the plurality of concepts and actions corresponding to the plurality of domains. A capsule according to an example embodiment may include a plurality of action objects (or action information) and concept objects (or concept information) included in the plan. According to an example embodiment, the capsule DB 230 may store a plurality of capsules in the form of a concept action network (CAN). According to an example embodiment, the plurality of capsules may be stored in a function registry included in the capsule DB 230.

The capsule DB 230 may include a strategy registry that stores strategy information necessary for determining a plan corresponding to a voice input. The strategy information may include reference information for determining one plan when there are a plurality of plans corresponding to the voice input. According to an example embodiment, the capsule DB 230 may include a follow-up registry that stores information on follow-up actions for suggesting a follow-up action to the user in a designated situation. The follow-up action may include, for example, a follow-up utterance. According to an example embodiment, the capsule DB 230 may include a layout registry that stores layout information that is information output through the electronic device 101. According to an example embodiment, the capsule DB 230 may include a vocabulary registry that stores vocabulary information included in capsule information. According to an example embodiment, the capsule DB 230 may include a dialog registry that stores information on a dialog (or an interaction) with the user. The capsule DB 230 may update the stored objects through a developer tool. The developer tool may include, for example, a function editor for updating an action object or a concept object. The developer tool may include a vocabulary editor for updating the vocabulary. The developer tool may include a strategy editor for generating and registering a strategy for determining a plan. The developer tool may include a dialog editor for generating a dialog with the user. The developer tool may include a follow-up editor for activating a follow-up objective and editing a follow-up utterance that provides a hint. The follow-up objective may be determined based on a current set objective, a preference of the user, or an environmental condition. In an example embodiment, the capsule DB 230 may be implemented in the electronic device 101 as well.

The execution engine 240 may calculate a result using the generated plan. The end user interface 250 may transmit the calculated result to the electronic device 101. Accordingly, the electronic device 101 may receive the result and provide the received result to the user. The management platform 260 may manage information used by the intelligent server 200. The big data platform 270 may collect data of the user. The analytic platform 280 may manage a quality of service (QoS) of the intelligent server 200. For example, the analytic platform 280 may manage the components and processing rate (or efficiency) of the intelligent server 200.

The service server 300 may provide a designated service (e.g., food order or hotel reservation) to the electronic device 101. According to an example embodiment, the service server 300 may be a server operated by a third party. The service server 300 may provide information to be used for generating a plan corresponding to the received voice input to the intelligent server 200. The provided information may be stored in the capsule DB 230. In addition, the service server 300 may provide result information according to the plan to the intelligent server 200.

In the integrated intelligence system 20 described above, the electronic device 101 may provide various intelligent services to the user in response to a user input. The user input may include, for example, an input through a physical button, a touch input, or a voice input.

In an example embodiment, the electronic device 101 may provide a speech recognition service through an intelligent app (or a speech recognition app) stored therein. In this case, for example, the electronic device 101 may recognize a user utterance or a voice input received through the microphone, and provide a service corresponding to the recognized voice input to the user.

In an example embodiment, the electronic device 101 may perform a designated action alone or together with the intelligent server and/or a service server, based on the received voice input. For example, the electronic device 101 may execute an app corresponding to the received voice input and perform a designated action through the executed app.

In one example embodiment, when the electronic device 101 provides a service together with the intelligent server 200 and/or the service server 300, the electronic device 101 may detect a user utterance using the microphone 150-1 and generate a signal (or voice data) corresponding to the detected user utterance. The electronic device 101 may transmit the voice data to the intelligent server 200 using the interface 177.

The intelligent server 200 may generate, as a response to the voice input received from the electronic device 101, a plan for performing a task corresponding to the voice input or a result of performing an action according to the plan. The plan may include, for example, a plurality of actions for performing a task corresponding to a voice input of a user, and a plurality of concepts related to the plurality of actions. The concepts may define parameters input to the execution of the plurality of actions or result values output by the execution of the plurality of actions. The plan may include connection information between the plurality of actions and the plurality of concepts.

The electronic device 101 may receive the response using the interface 177. The electronic device 101 may output a voice signal internally generated by the electronic device 101 to the outside using the speaker 155-1, or output an image internally generated by the electronic device 101 to the outside using the display module 160.

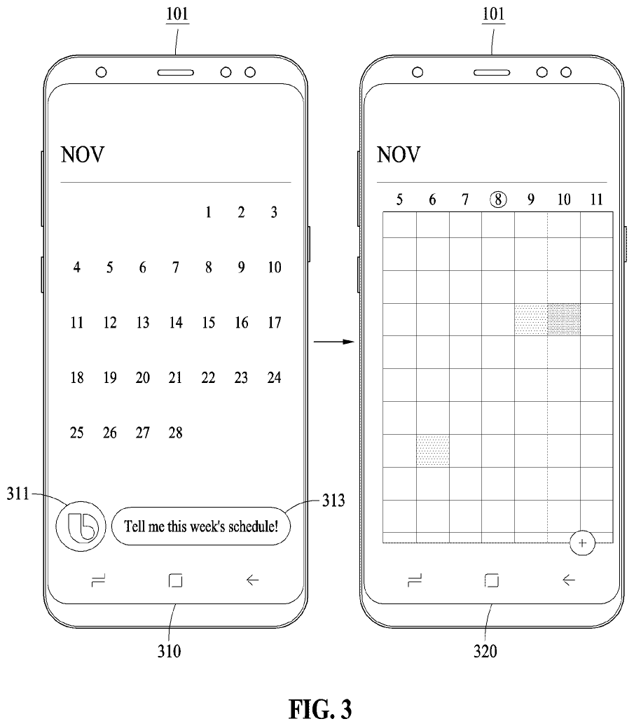

FIG. 3 is a diagram illustrating a screen of an electronic device processing a received voice input through an intelligent app, according to an example embodiment.

An electronic device 101 may execute an intelligent app to process a user input through an intelligent server (e.g., the intelligent server 200 of FIG. 2).

According to an example embodiment, on a screen 310, when a designated voice input (e.g., Wake up!) is recognized or an input through a hardware key (e.g., a dedicated hardware key) is received, the electronic device 101 may execute an intelligent app for processing the voice input. The electronic device 101 may execute the intelligent app, for example, in a state in which a scheduling app is executed. According to an example embodiment, the electronic device 101 may display an object (e.g., an icon) 311 corresponding to the intelligent app on a display (e.g., the display module 160 of FIG. 1). According to an example embodiment, the electronic device 101 may receive a voice input by a user utterance. For example, the electronic device 101 may receive a voice input of “Tell me this week's schedule!”. According to an example embodiment, the electronic device 101 may display a user interface (UI) 313 (e.g., an input window) of the intelligent app in which text data of the received voice input is displayed on the display.

According to an example embodiment, on a screen 320, the electronic device 101 may display a result corresponding to the received voice input on the display. For example, the electronic device 101 may receive a plan corresponding to the received user input, and display “this week's schedule” on the display according to the plan.

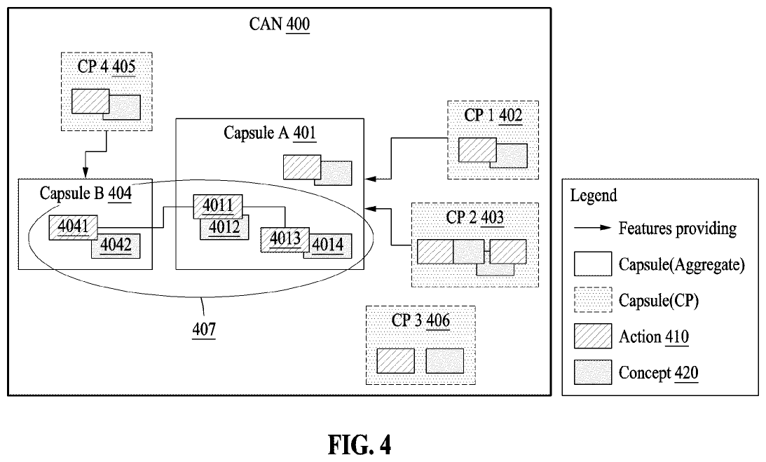

FIG. 4 is a diagram illustrating a form in which relationship information between concepts and actions is stored in a database, according to an example embodiment.

A capsule DB (e.g., the capsule DB 230 of FIG. 2) of an intelligent server (e.g., the intelligent server 200 of FIG. 2) may store capsules in the form of a concept action network (CAN). The capsule DB may store an action for processing a task corresponding to a voice input of a user and a parameter necessary for the action in the form of a CAN.

The capsule DB may store a plurality of capsules (a capsule A 401 and a capsule B 404) respectively corresponding to a plurality of domains (e.g., applications). According to an example embodiment, one capsule (e.g., the capsule A 401) may correspond to one domain (e.g., a location (geo) or an application). Further, the one capsule may correspond to at least one service provider (e.g., CP 1 402 or CP 2 403) for performing a function for a domain related to the capsule. According to an example embodiment, one capsule may include at least one or more action 410 for performing a designated function and at least one or more concept 420.

A natural language platform (e.g., the natural language platform 220 of FIG. 2) may generate a plan for performing a task corresponding to the received voice input using the capsules stored in the capsule DB. For example, a planner module (e.g., the planner module 225 of FIG. 2) of the natural language platform may generate the plan using the capsules stored in the capsule DB. For example, a plan 407 may be generated using actions 4011 and 4013 and concepts 4012 and 4014 of the capsule A 401 and an action 4041 and a concept 4042 of the capsule B 404.

The electronic device according to embodiments may be one of various types of electronic devices. The electronic device may include, for example, a portable communication device (e.g., a smartphone), a computer device, a portable multimedia device, a portable medical device, a camera, a wearable device, or a home appliance device. According to an example embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. Terms such as “1^{st},” “2^{nd},” or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via at least a third element.

As used in connection with embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an example embodiment, the module may be implemented in a form of an application-specific integrated circuit (ASIC). Thus, each “module” herein may comprise circuitry.

Embodiments as set forth herein may be implemented as software (e.g., the program 140) including one or more instructions that are stored in a storage medium (e.g., an internal memory 136 or an external memory 138) that is readable by a machine (e.g., the electronic device 101 of FIG. 1). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more of instructions may include a code generated by a compiler or a code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an example embodiment, a method according to certain example embodiments may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as a memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

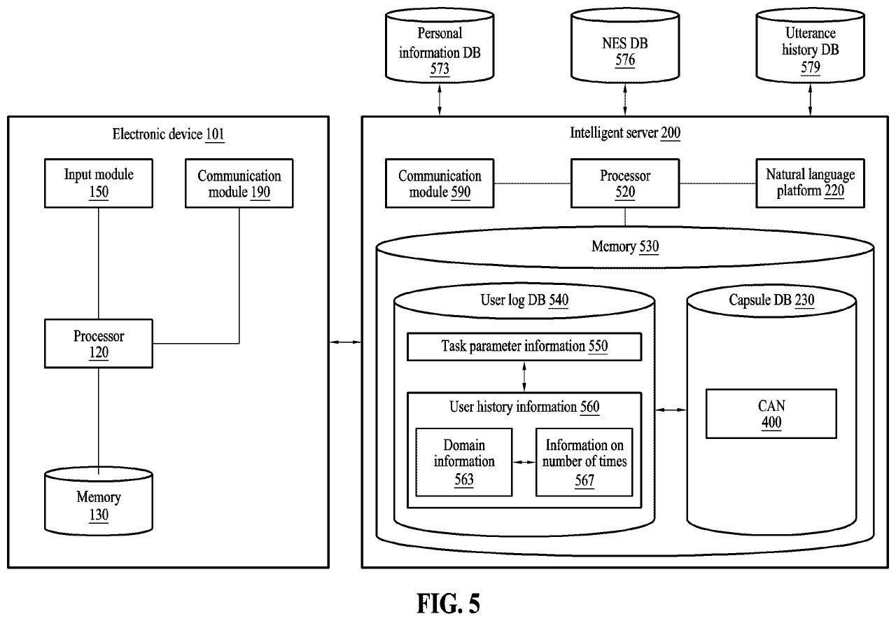

FIG. 5 is a block diagram illustrating the electronic device 101 and the intelligent server 200, according to an example embodiment.

The electronic device 101 of FIG. 5 may include at least some of the components of the electronic device 101 described with reference to FIG. 1 and the electronic device 101 described with reference to FIG. 2. The intelligent server 200 of FIG. 5 may include at least some of the components of the intelligent server 200 described with reference to FIG. 2. With respect to the electronic device 101 and the intelligent server 200 of FIG. 5, the descriptions provided with reference to FIGS. 1 to 4 will not be repeated.

Referring to FIG. 5, the electronic device 101 may include an input module 150, comprising circuitry, for inputting a user utterance, a communication module 190, comprising communication circuitry, for communicating with the intelligent server 200 that processes the user utterance, a memory 130 for storing computer-executable instructions and/or a processor 120 for executing the computer-executable instructions by accessing the memory 130. The electronic device 101, the input module 150, the communication module 190, the memory 130, and/or the processor 120 may respectively correspond to the electronic device 101, the input module 150, the communication module 190, the memory 130, and/or the processor 120 described with reference to FIG. 1. The electronic device 101 may be the electronic device 101 for performing communication with the intelligent server 200 described with reference to FIG. 2, and the client module 151 may be included in the memory 130.

According to an example embodiment, in addition to the components illustrated in FIG. 5, the electronic device 101 may further include various components as described above with reference to FIG. 1. For example, the electronic device 101 may further include the sound output module 155 for providing a result of processing a user utterance in a form of auditory feedback to a user or the display module 160, comprising at least one display, for providing the processing result in a form of visual and tactile feedback.

According to an example embodiment, the processor 120 may receive the user utterance through the input module 150, for example a microphone, and transmit information on the user utterance and the electronic device 101 to the intelligent server 200. According to an example embodiment, the information on the electronic device 101 may include at least one among account information of the electronic device 101, information on a current location of the electronic device 101, and information on an application of the electronic device 101. However, examples are not limited thereto, and the processor 120 may transmit various kinds of information on the electronic device 101 to the intelligent server 200.

According to an example embodiment, the processor 120, comprising processing circuitry, may control to transmit information on a user utterance and the electronic device 101 to the intelligent server 200, through the communication module 190, and output a result of processing the utterance to a user based on an instruction received from the intelligent server 200. For example, as described above, the electronic device 101 may further include the sound output module 155 and provide the result of processing the user utterance in a form of sound through the sound output module 155.

According to an example embodiment, the intelligent server 200 may include a natural language platform 220, a capsule DB 230, a communication module 590, a processor 520, and/or a memory 530. According to an example embodiment, the intelligent server 200 may be the intelligent server 200 described with reference to FIG. 2, and the communication module 590 (comprising communication circuitry), the processor 520, the memory 530, the natural language platform 220, and/or the capsule DB 230 may correspond to the components of the intelligent server 200 of FIG. 2.

According to an example embodiment, the communication module 590 may correspond to the front end 210 of FIG. 2. The processor 520, comprising processing circuitry, may receive information on the user utterance and the electronic device 101 from the electronic device 101 through the communication module 590. According to an example embodiment, the intelligent server 200 may receive, from the electronic device 101 and other electronic devices (not shown) interoperating with the electronic device 101, information (e.g., information on an application installed on the electronic device) on each electronic device through the communication module 590. For example, a user may use various electronic devices, such as an intelligent speaker, a smart watch, and/or a smart TV, corresponding to a user account of the electronic device 101 (e.g., a smartphone), and the intelligent server 200 may receive, from the intelligent speaker and/or the smart watch, information on an application installed on the device.

According to an example embodiment, the processor 520 may generate a result of processing an utterance received from the electronic device 101 and transmit the processing result to the electronic device 101 through the communication module 590.

According to an example embodiment, the natural language platform 220, as described with reference to FIG. 2, may include an ASR module 221, an NLU module 223, a planner module 225, an NLG module 227, and a TTS module 229. According to an example embodiment, the memory 530 may include the capsule DB 230. As described with reference to FIG. 2, the capsule DB 230 may store an action for processing a task corresponding to a voice input of a user and a task parameter for performing the action in a form of the CAN 400. The CAN 400 may be configured as described with reference to FIG. 4.

According to an example embodiment, the memory 530 of the intelligent server 200 may store a user log DB 540. The user log DB 540 may include task parameter information 550 of at least one client terminal (e.g., the electronic device 101) for performing communication with the intelligent server 200 and user history information 560 corresponding to the task parameter information 550.

According to an example embodiment, the task parameter information 550 may include information on a task parameter that has been input from the at least one client terminal. The task parameter may be a parameter for performing an action according to a user intent. The task parameter may be referred to as a slot.

Various task parameters, such as a target on which an action is to be performed and means for performing the action, may be provided, and the task parameters may or may not be included in a user utterance. For example, in a user utterance “Order an Americano”, “an Americano”, which is a target on which an action “Order” is to be performed, may be a task parameter. As another example, in a user utterance “Tell me today's weather,” “weather,” which is a target on which an action “Tell me” is to be performed, “today's,” which is time information used to specify the weather, and “Seoul,” which is area information that may be obtained to correspond to account information of a client terminal but not included in the utterance, may be task parameters.

According to an example embodiment, the task parameter may be determined from a target utterance received from a user with reference to the capsule DB 230. As described above, the task parameter may be determined based on the target utterance. A task parameter not included in the target utterance may be obtained based on account information of a client terminal (e.g., the electronic device 101).

According to an example embodiment, the user log DB 540 may include the task parameter information 550 that has been input from the at least one client terminal and the user history information 560 corresponding to each task parameter. The user history information 560 may include domain information 563 determined to correspond to the task parameter information 550 according to the account information and information 567 on a number of times a domain is designated. For example, the domain information 563 and the information 567 on the number of times included in the user history information 560 corresponding to the task parameter information 550 of “an Americano” may be configured as follows. The domain information 563 may include information indicating that a ‘Star Coffee’ application is designated as a target domain corresponding to “an Americano”, and the information 567 on the number of times may include information indicating that the ‘Star Coffee’ application corresponding to the task parameter “an Americano” is designated three times.

According to an example embodiment, the domain information 563 (e.g., geolocation or an application) may correspond to the capsule described above with reference to FIGS. 2 to 4. For example, a domain may be software for processing a target utterance through the electronic device 101 and may include at least one among an application downloadable to the electronic device 101, a program for providing a service in a form of a widget, and a web app.

The user history information 560 corresponding to the task parameter information 550 may be obtained or learned based on a personal information DB 573, a named entity service (NES) DB 576, and an utterance history information DB 579.

According to an example embodiment, the personal information DB 573 may include at least one among information on an installed application corresponding to account information of each client terminal (e.g., the electronic device 101) for communicating with the intelligent server 200, information on frequency of use of the application, contact information, account name information, interworking device information, and information on a domain determined to correspond to each information.

According to an example embodiment, the NES DB 576 may include at least one among information on a named entity, such as a movie and music, metadata corresponding to the named entity, and information on a domain determined to correspond to each type of information. For example, the NES DB 576 may include information indicating that “The Phantom of the Opera” is a song title, information indicating that the song is foreign music, and information on a domain that has been designated to play foreign music.

According to an example embodiment, the utterance history information DB 579 may include utterance history information corresponding to the account information of each client terminal (e.g., the electronic device 101) for communicating with the intelligent server 200 and information on a domain determined to correspond to utterance history.

According to an example embodiment, the user history information 560 may be learned based on deep learning according to the account information of each client terminal (e.g., the electronic device 101) for communicating with the intelligent server 200. For example, with reference to the personal information DB 573, the NES DB 576, and the utterance history DB 579, the domain information 563 corresponding to the task parameter information 550 and the information 567 on the number of times a domain is designated may be learned according to user account information. For example, with respect to the task parameter “The Phantom of the Opera” corresponding to account information of the electronic device 101, information indicating that the task parameter is a title of foreign music may be obtained with reference to the NES DB 576, and information indicating that an application called ‘Spoty’ has been designated as a target domain five times to play foreign music may be included in the user history information 560.

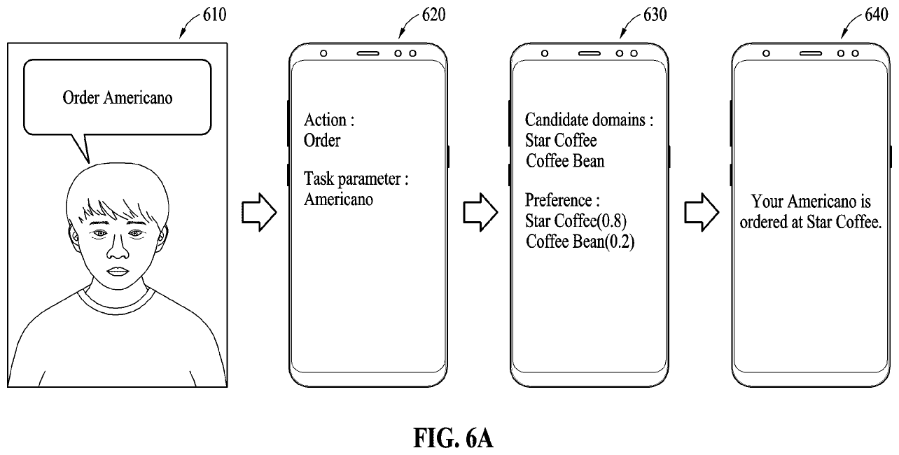

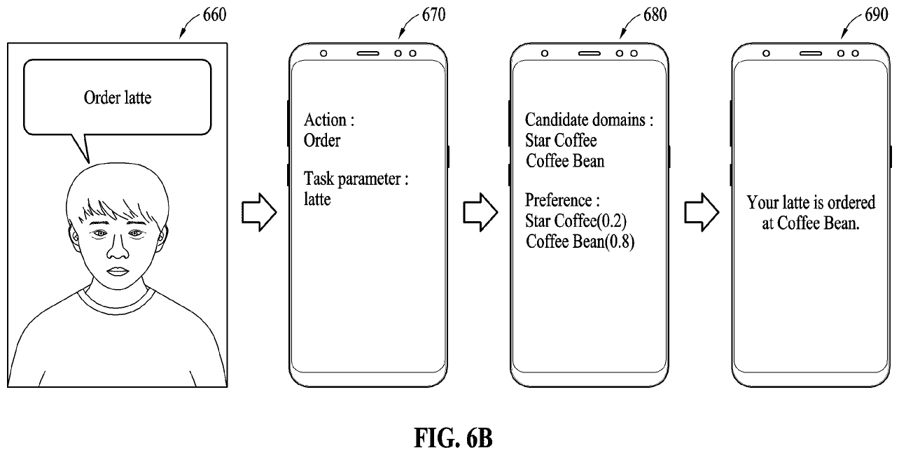

According to an example embodiment, in response to a plurality of candidate domains for processing a target utterance being provided, a user preference for each of the plurality of candidate domains may be calculated based on the user history information 560 corresponding to the task parameter information 550, and a target domain may be designated based on a calculation result. An example embodiment in which the plurality of candidate domains is provided is described in detail with reference to FIGS. 6A through 10B and 12.

Detailed descriptions of a scheme of determining a target domain using the user history information 560 are provided with reference to FIGS. 6A through 10B.

FIG. 5 illustrates that the personal information DB 573, the NES DB 576, and the utterance history DB 579 are separated from and communicate with the intelligent server 200, but examples are not limited thereto. For example, in addition to the personal information DB 573, the NES DB 576, and the utterance history DB 579, various types of DBs may be used to obtain the user history information 560, and at least some of DBs may be included in the memory 530 of the intelligent server 200.

The user log DB 540 and the capsule DB 230 are illustrated as being separate in FIG. 5, but examples are not limited thereto, and the user log DB 540 may be included in the capsule

According to an example embodiment, the memory 530 for storing computer-executable instructions and the processor 520 for executing the computer-executable instructions by accessing the memory 530 may correspond to the natural language platform 220 or the execution engine 240 of the intelligent server 200 described with reference to FIG. 2. For example, the processor 520 may generate a plan with reference to the capsule DB 230 or the user history information 560 as described with reference to the natural language platform 220 of FIG. 2 and generate a processing result according to the plan as described with reference to the execution engine 240 of FIG. 2.

According to an example embodiment, the processor 520, through the communication module 590, may receive a target utterance from the electronic device 101, generate a result of processing the target utterance with reference to the natural language platform 220, the capsule DB 230, and the user log DB 540, and transmit the generated processing result to the electronic device 101.

According to an example embodiment, a program (e.g., the program 140 of FIG. 1) for determining a task parameter with respect to a target utterance and determining a target domain for processing the target utterance with reference to the user history information 560 corresponding to the task parameter may be stored in the memory 530 as software.

According to an example embodiment, on-device AI for processing an utterance without communication with the intelligent server 200 may be included in the electronic device 101. For example, as described with reference to FIGS. 2 through 4, the ASR module 221 of the natural language platform 220 may be implemented in the electronic device 101, and at least a part of the user log DB 540 may be included in the memory 130 of the electronic device. According to an example embodiment, the program (e.g., the program 140 of FIG. 1) for determining the task parameter with respect to the target utterance and determining the target domain for processing the target utterance with reference to the user history information 560 corresponding to the task parameter may be stored in the memory 130 of the electronic device 101 as software.

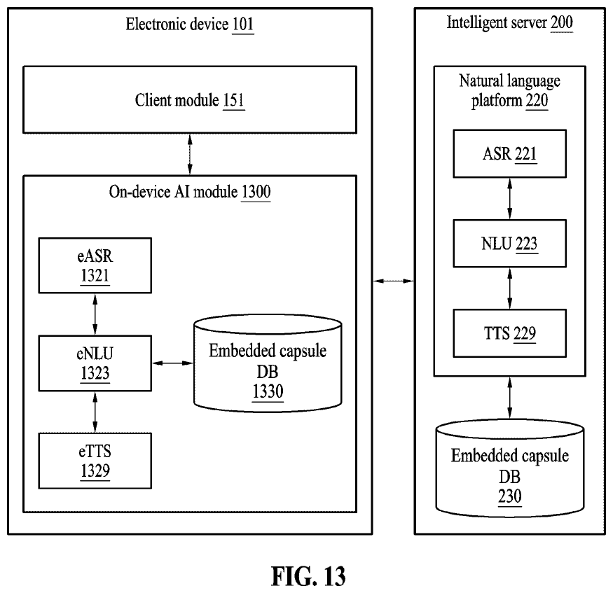

According to an example embodiment, when the on-device AI is included in the electronic device 101 and functions of an intelligent server are implemented in the electronic device 101, only some of the functions of the intelligent server 200 may be implemented in the electronic device 101. For example, only some of the components (e.g., the ASR module 221) of the natural language platform 220 of the intelligent server 200 described with reference to FIG. 2 may be implemented in the electronic device 101. According to an example embodiment, for example, some of functions of the capsule DB 230 for storing a capsule in a form of the ASR module 221, the NLU module 223, and the CAN 400 may be implemented in the electronic device 101, and functions that are not implemented with the on-device AI may be processed through the intelligent server 200. A configuration of the electronic device 101 on which the on-device AI is mounted is described in detail with reference to FIG. 13.

According to an example embodiment, the computer-executable instructions stored in the memory 530 or the memory 130 may be implemented as one function module in the OS 142, implemented in a form of the middleware 144, or implemented in a separate application (e.g., the application 146).

FIGS. 6A to 10B provide detailed descriptions of a scheme in which the processor 120 of the electronic device 101 or the processor 520 of the intelligent server 200 designates a target domain for processing a target utterance based on the user history information 560 corresponding to a task parameter of the target utterance received from a user.

FIGS. 6A to 10B are diagrams illustrating an operation of the intelligent server 200 to process a user utterance, according to an example embodiment.

For brevity, FIGS. 6A to 10B illustrate that a target utterance is processed by the electronic device 101, however, the target utterance may be transmitted to the intelligent server 200 and processed by the processor 520 of the intelligent server 200 as illustrated in FIG. 5. In addition, FIGS. 6A to 10B mainly describe an operation of the processor 520 of the intelligent server 200, but the examples are not limited thereto. For example, as described above with reference to FIG. 5, on-device AI may be mounted on the electronic device 101, and the processor 120 of the electronic device 101 may process a target utterance of a user without communicating with the intelligent server 200.

FIGS. 6A and 6B illustrate that the processor 520 of the intelligent server 200 differently processes a target utterance used to order a coffee based on user history information according to a task parameter.

Referring to FIG. 6A, in operation 610, a target utterance of a user “Order an American” is input to the electronic device 101, and the target utterance is transmitted to the intelligent server 200.

In operation 620, the processor 520 of the intelligent server 200 may analyze the target utterance “Order an Americano” to determine an action and a task parameter. For example, the processor 520 may determine that an action according to a user intent is “Order” and that a task parameter for performing the action is “an Americano” with reference to the capsule DB 230 for storing data (e.g., a capsule) in a form of the CAN 400.

In operation 630, the processor 520 may determine candidate domains for processing the target utterance and calculate a user preference for each of the candidate domains with reference to the user log DB 540. For example, the processor 520 may determine that the candidate domains for processing the target utterance are a ‘Star Coffee’ application and a ‘Coffee Bean’ application with reference to the capsule DB 230.

According to an example embodiment, the processor 520 may calculate a user preference for each of the candidate domains with reference to the user log DB 540. For example, the processor 520 may refer to the user history information 560 corresponding to the task parameter “an Americano” in the user log DB 540 and refer to the domain information 563 corresponding to “an Americano” and the information 567 on the number of times a corresponding domain is designated. The processor 520 may identify that the ‘Star Coffee’ and ‘Coffee Bean’ applications have been designated as a target domain eight times and two times, respectively, with respect to the task parameter “an Americano”. The processor 520 may calculate preferences for the candidate domains, the ‘Star Coffee’ and ‘Coffee Bean’ applications, at 0.8 and 0.2, respectively, with reference to the domain information 563 and the information 567 on the number of times included in the user history information 560 with respect to the task parameter “an Americano.” However, the examples are not limited thereto, and a user preference for each candidate domain may be determined in various ways with reference to the user history information 560.

In operation 640, the processor 520 may designate the ‘Star Coffee’ application, a domain most preferred by the user, as the target domain, generate a result of processing the target utterance based on the target domain and transmit the result to the electronic device 101. For example, the processor 520 may generate the result of processing “Order an Americano on the ‘Star Coffee’ application” and transmit the result to the electronic device 101. Referring to FIG. 6B, in operation 660, a target utterance of the user “Order a latte” is input to the electronic device 101 and the target utterance is transmitted to the intelligent server 200.

In operation 670, the processor 520 of the intelligent server 200 may analyze the target utterance “Order a latte” to determine an action and a task parameter. For example, the processor 520 may determine that an action according to a user intent is “Order” and that a task parameter for performing the action is “a latte” with reference to the capsule DB 230 for storing data (e.g., a capsule) in a form of the CAN 400.

In operation 680, the processor 520 may determine candidate domains for processing the target utterance and calculate a user preference for each of the candidate domains with reference to the user log DB 540. For example, the processor 520 may determine that the candidate domains for processing the target utterance are a ‘Star Coffee’ application and a ‘Coffee Bean’ application with reference to the capsule DB 230.

According to an example embodiment, the processor 520 may calculate a user preference for each of the candidate domains with reference to the user log DB 540. For example, the processor 520 may identify the user history information 560 corresponding to the task parameter “a latte” in the user log DB 540 and refer to the domain information 563 corresponding to “a latte” and the information 567 on the number of times a corresponding domain is designated. The processor 520 may identify that the ‘Coffee Bean’ and ‘Star Coffee’ applications have been designated as a target domain eight times and two times, respectively, with respect to the task parameter ‘a latte’. The processor 520 may calculate preferences for the candidate domains, the ‘Coffee Bean’ and ‘Star Coffee’ applications, at 0.8 and 0.2, respectively, with reference to the domain information 563 and the information 567 on the number of times included in the user history information with respect to the task parameter “a latte.” However, the examples are not limited thereto, and a user preference for each candidate domain may be determined in various ways with reference to the user history information 560.

In operation 690, the processor 520 may designate the ‘Coffee Bean’ application, a domain most preferred by the user, as the target domain, generate a result of processing the target utterance based on the target domain and transmit the result to the electronic device 101. For example, the processor 520 may generate the result of processing “Order a latte on the ‘Coffee Bean’ application” and transmit the result to the electronic device 101.

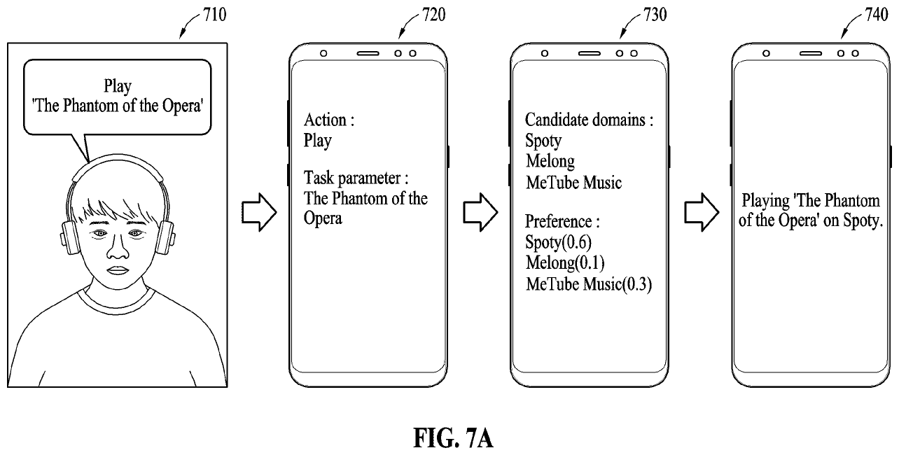

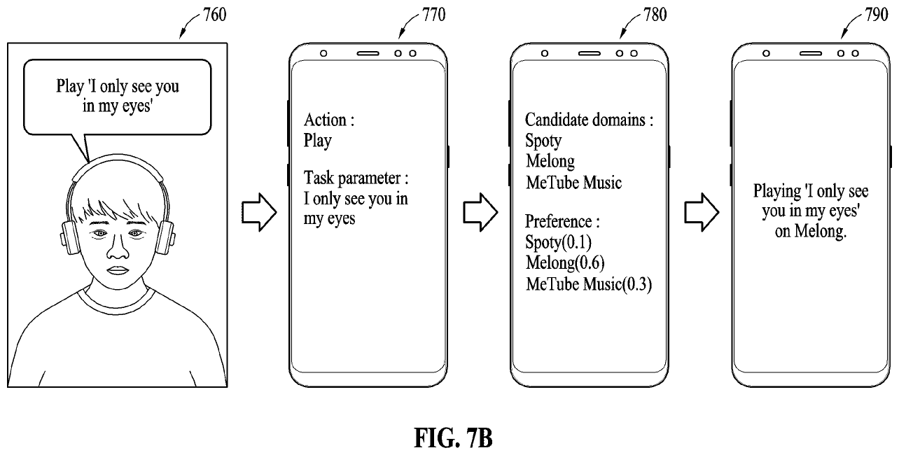

FIGS. 7A and 7B illustrate that the processor 520 of the intelligent server 200 differently processes a target utterance used to make a request to play music based on user history information according to a task parameter.

Referring to FIG. 7A, in operation 710, a target utterance of a user “Play The Phantom of the Opera” is input to the electronic device 101, and the target utterance is transmitted to the intelligent server 200.

In operation 720, the processor 520 of the intelligent server 200 may analyze the target utterance “Play The Phantom of the Opera” to determine an action and a task parameter. For example, the processor 520 may determine that an action according to a user intent is “Play” and that a task parameter for performing the action is “The Phantom of the Opera” with reference to the capsule DB 230 for storing data (e.g., a capsule) in a form of the CAN 400.

In operation 730, the processor 520 may determine candidate domains for processing the target utterance and calculate a user preference for each of the candidate domains with reference to the user log DB 540. For example, the processor 520 may determine that the candidate domains for processing the target utterance are a ‘Spoty’ application, a ‘Melong’ application, and a ‘MeTube Music’ application with reference to the capsule DB 230.

According to an example embodiment, the processor 520 may calculate a user preference for each of the candidate domains with reference to the user log DB 540. For example, the processor 520 may identify the user history information 560 corresponding to the task parameter “The Phantom of the Opera” in the user log DB 540 and refer to the domain information 563 corresponding to “The Phantom of the Opera” and the information 567 on the number of times a corresponding domain is designated.

According to an example embodiment, based on the NES DB 576, information indicating that “The Phantom of the Opera” is foreign music, classified as a ‘Pop’ genre, and performed by ‘Gerard Butler’ may be included in the user history information 560, and information indicating that a user of a corresponding client terminal 101 has played foreign music on the ‘Spoty’ application may be included in the user history information 560. For example, the processor 520 may identify that the ‘Spoty,’ ‘Melong,’ and ‘MeTube Music’ applications have been designated as a target domain six times, one time, and three times, respectively, with respect to the information ‘foreign music,’ which is property information of the task parameter “The Phantom of the Opera,” with reference to the user history information 560. The processor 520 may calculate preferences for the candidate domains, the ‘Spoty’, ‘Melong’, and ‘MeTube Music’ applications, at 0.6, 0.1, and 0.3, respectively, with reference to the domain information 563 and the information 567 on the number of times included in the user history information 560 corresponding to the task parameter “The Phantom of the Opera”. However, examples are not limited thereto, and a user preference for each candidate domain may be determined in various ways with reference to the user history information 560.

In operation 740, the processor 520 may designate the ‘Spoty’ application, a domain most preferred by the user, as the target domain, generate a result of processing the target utterance based on the target domain and transmit the result to the electronic device 101. For example, the processor 520 may generate the result of processing “Play ‘The Phantom of the Opera’ on the ‘Spoty’ application” and transmit the result to the electronic device 101.

Referring to FIG. 7B, in operation 760, a target utterance of the user “Play I only see you in my eyes” may be input to the electronic device 101, and the target utterance may be transmitted to the intelligent server 200.

In operation 770, the processor 520 of the intelligent server 200 may analyze the target utterance “Play I only see you in my eyes” to determine an action and a task parameter. For example, the processor 520 may determine that an action according to a user intent is “Play” and that a task parameter for performing the action is “I only see you in my eyes” with reference to the capsule DB 230 for storing data (e.g., a capsule) in a form of the CAN 400.

In operation 780, the processor 520 may determine candidate domains for processing the target utterance and calculate a user preference for each of the candidate domains with reference to the user log DB 540. For example, the processor 520 may determine that the candidate domains for processing the target utterance are the ‘Spoty’ application, ‘Melong’ application, and ‘MeTube Music’ application with reference to the capsule DB 230.

According to an example embodiment, the processor 520 may calculate a user preference for each of the candidate domains with reference to the user log DB 540. For example, the processor 520 may identify the user history information 560 corresponding to the task parameter “I only see you in my eyes” in the user log DB 540 and refer to the domain information 563 corresponding to “I only see you in my eyes” and the information 567 on the number of times a corresponding domain is designated.

According to an example embodiment, based on the NES DB 576, information indicating that “I only see you in my eyes” is Korean music, classified as a ‘Ballad’ genre, and performed by ‘Espresso’ may be included in the user history information 560, and information indicating that a user of a corresponding client terminal 101 has played Korean music on the ‘Melong’ application may be included in the user history information 560. For example, the processor 520 may identify that the ‘Spoty,’ ‘Melong,’ and ‘MeTube Music’ applications have been designated as a target domain one time, six times, and three times, respectively, with respect to ‘Korean music,’ which is property information of the task parameter “I only see you in my eyes” with reference to the user history information 560. The processor 520 may calculate preferences for the candidate domains, the ‘Spoty’, ‘Melong’, and ‘MeTube Music’ applications, at 0.1, 0.6, and 0.3, respectively, with reference to the domain information 563 and the information 567 on the number of times included in the user history information 560 corresponding to the task parameter “I only see you in my eyes.” However, the examples are not limited thereto, and a user preference for each candidate domain may be determined in various ways with reference to the user history information 560.

In operation 790, the processor 520 may designate the ‘Melong’ application, a domain most preferred by the user, as the target domain, generate a result of processing the target utterance based on the target domain and transmit the result to the electronic device 101. For example, the processor 520 may generate the result of processing “Play ‘I only see you in my eyes’ on the ‘Melong’ application” and transmit the result to the electronic device 101.

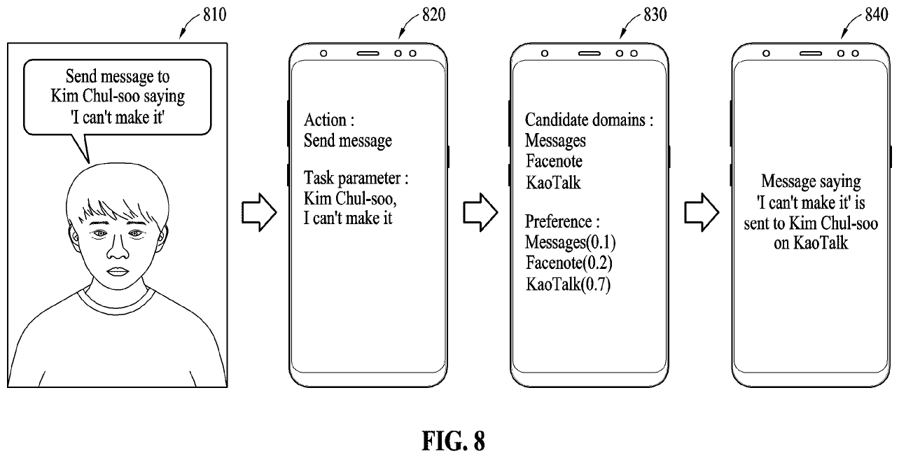

FIG. 8 illustrates that the processor 520 of the intelligent server 200 processes a target utterance used to make a request to send a message based on user history information according to a task parameter.

Referring to FIG. 8, in operation 810, a target utterance “Send a message to Kim Chul-soo saying ‘I can't make it’” may be input to the electronic device 101, and the target utterance may be transmitted to the intelligent server 200.

In operation 820, the processor 520 of the intelligent server 200 may analyze the target utterance “Send a message to Kim Chul-soo saying ‘I can't make it’” to determine an action and task parameters. For example, the processor 520 may determine that an action according to a user intent is “Send a message” and that task parameters to perform the action are “to Kim Chul-soo” and “I can't make it” with reference to the capsule DB 230 for storing data (e.g., a capsule) in a form of the CAN 400.

In operation 830, the processor 520 may determine candidate domains for processing the target utterance and calculate a user preference for each of the candidate domains with reference to the user log DB 540. For example, the processor 520 may determine that the candidate domains for processing the target utterance are a ‘Messages’ application, a ‘Facenote’ application, and a ‘KaoTalk’ application with reference to the capsule DB 230.

According to an example embodiment, the processor 520 may calculate a user preference for each of the candidate domains with reference to the user log DB 540. For example, the processor 520 may identify the user history information 560 corresponding to the task parameters “Kim Chul-soo” and “I can't make it” in the user log DB 540 and refer to the domain information 563 corresponding to “Kim Chul-soo” and “I can't make it” and the information 567 on the number of times a corresponding domain is designated.

According to an example embodiment, based on the personal information DB 573, information indicating that “Kim Chul-soo” is a name of a contact stored in the electronic device 101, which is a client terminal, may be included in the user history information 560, and information indicating that the ‘KaoTalk’ application is mainly used to contact “Kim Chul-soo” may be included in the user history information 560. For example, the processor 520 may identify that the ‘Messages,’ ‘Facenote,’ and ‘KaoTalk’ applications have been designated as a target domain one time, two times, and six times, respectively, with respect to the task parameter “Kim Chul-soo” with reference to the domain information 563 and the information 567 on the number of times included in the user history information 560. The processor 520 may calculate preferences for the candidate domains, the ‘Messages,’ ‘Facenote,’ and ‘KaoTalk’ applications, at 0.1, 0.2, and 0.7, respectively, with respect to the task parameter “Kim Chul-soo” with reference to the domain information 563 and the information 567 on the number of times included in the user history information 560. However, the examples are not limited thereto, and a user preference for each candidate domain may be determined in various ways with reference to the user history information 560.

In operation 840, the processor 520 may designate the ‘KaoTalk’ application, a domain most preferred by the user, as the target domain, generate a result of processing the target utterance based on the target domain, and transmit the result to the electronic device 101. For example, the processor 520 may generate the result of processing “Send a message to Kim Chul-soo saying ‘I can't make it’ on the ‘KaoTalk’ application” and transmit the result to the electronic device 101.

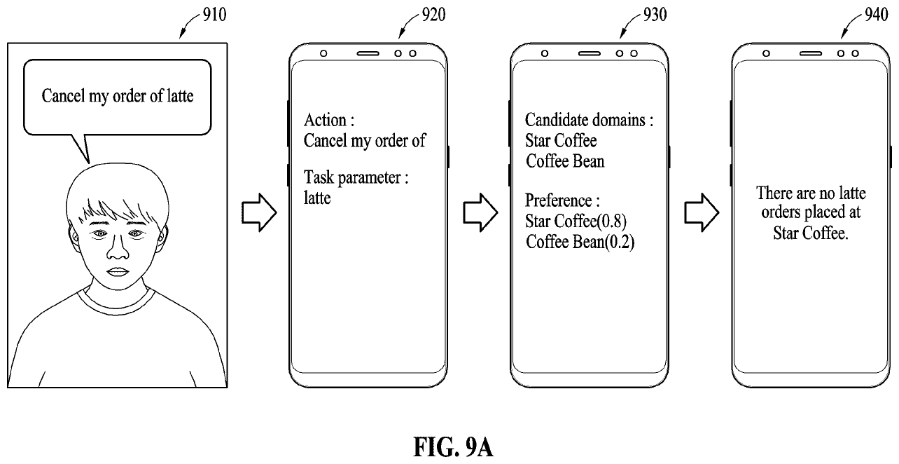

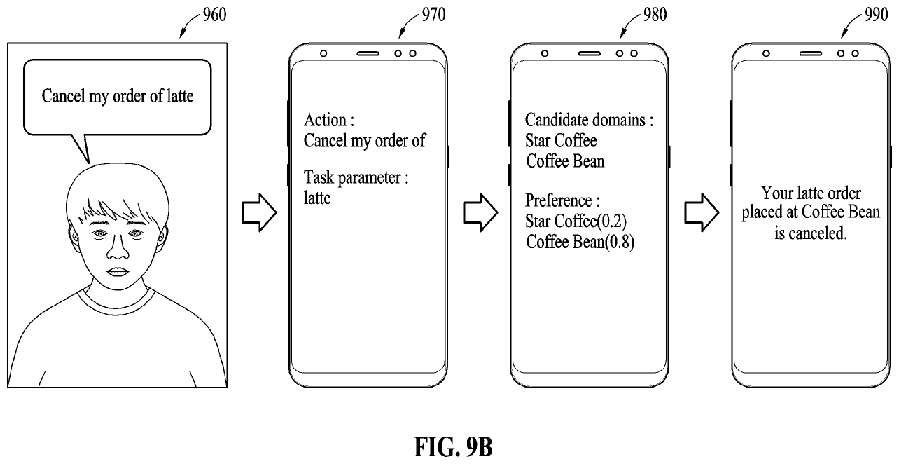

FIGS. 9A and 9B illustrate that the processor 520 of the intelligent server 200 differently processes a target utterance used to make a request for order cancellation according to whether user history information according to a task parameter is used. FIGS. 9A and 9B illustrate embodiments, assuming that a latte order has been placed on a ‘Coffee Bean’ application.

FIG. 9A illustrates that the processor processes a target utterance “Cancel my order of a latte” without considering the user history information 560 corresponding to the task parameter described above with reference to FIG. 5.

In operation 910, the target utterance of a user “Cancel my order of a latte” may be input to the electronic device 101, and the target utterance may be transmitted to the intelligent server 200.

In operation 920, the processor 520 of the intelligent server 200 may analyze the target utterance “Cancel my order of a latte” to determine an action and a task parameter. For example, the processor 520 may determine that an action according to a user intent is “Cancel my order of” and that a task parameter for performing the action is “a latte” with reference to the capsule DB 230 for storing data (e.g., a capsule) in a form of the CAN 400.

In operation 930, the processor 520 may determine candidate domains for processing the target utterance and calculate a user preference for each of the candidate domains. For example, the processor 520 may determine that the candidate domains for processing the target utterance are a ‘Star Coffee’ application and a ‘Coffee Bean’ application with reference to the capsule DB 230.

In operation 930, the processor 520 may calculate a user preference for each of the candidate domains without considering the user history information 560 corresponding to the task parameter. For example, when the processor 520 refers only to the utterance history DB 579 without considering the task parameter “a latte,” a value of a calculated preference for the ‘Star Coffee’ application may be high based on ‘information indicating that an utterance used to order a coffee is processed on the ‘Star Coffee’ application. Referring to FIG. 9A, preferences for the ‘Star Coffee’ and ‘Coffee Bean’ applications may be calculated at 0.8 and 0.2, respectively.

If the processor 520 does not consider the user history information 560 corresponding to the task parameter, a target domain that is not appropriate for a user intent may be designated in operation 940. In operation 930, without considering the user history information corresponding to the task parameter, it may be determined that the ‘Star Coffee’ application is a most preferred application, and accordingly, the ‘Star Coffee’ application may be designated as the target domain in operation 940.

In operation 940, because order history shows that a latte has been ordered only on the ‘Coffee Bean’ application, not on the ‘Star Coffee’ application, a result of processing “There are no latte orders placed on the ‘Star Coffee’ application” that is not appropriate for the user intent may be generated with respect to the target utterance “Cancel my order of a latte” and transmitted to the electronic device 101.

FIG. 9B illustrates that the processor processes the target utterance of “Cancel my order of a latte” considering the user history information 560 corresponding to the task parameter described above with reference to FIG. 5.

An example embodiment to be described with reference to FIG. 9B may be partially similar to the example embodiment of processing the target utterance of “Order a latte” described above with reference to FIG. 6B and the example embodiment of processing “Cancel my order of a latte” without using user history information described above with reference to FIG. 9A. Any repeated description related thereto has been omitted.

Descriptions provided with reference to operations 910 and 920 of FIG. 9A are applicable to operations 960 and 970, and thus, detailed descriptions related thereto have been omitted.

In operation 980, as described above with reference to operation 930 of FIG. 9A, the processor 520 may determine that the ‘Star Coffee’ application and the ‘Coffee Bean’ application are candidate domains that may process the target utterance with reference to the capsule DB 230.

In operation 980, the processor 520 may calculate a user preference for each of the candidate domains with reference to the user history information 560 corresponding to the task parameter. For example, when the processor 520 refers to the user history information 560 corresponding to the task parameter “a latte,” a value of a calculated preference for the ‘Coffee Bean’ application may be high based on ‘information indicating that a latter order is processed on the ‘Coffee Bean’ application.’ Referring to FIG. 9B, preferences for the ‘Star Coffee’ and ‘Coffee Bean’ applications may be calculated at 0.2 and 0.8, respectively.

If the processor 520 considers the user history information 560 corresponding to the task parameter, a target domain that is appropriate for the user intent may be designated in operation 990. For example, “Cancel my order of a latte on the ‘Coffee Bean’ application” may be generated as a processing result that is appropriate for the user intent based on order history showing that the user has ordered a latte on the ‘Coffee Bean’ application, and the processing result may be transmitted to the electronic device 101.

Unlike in the example embodiment described above with reference to FIG. 9A, in the example embodiment described with reference to FIG. 9B, a target domain is designated based on user history information for each task parameter such that a processing result that is appropriate for the user intent may be generated.

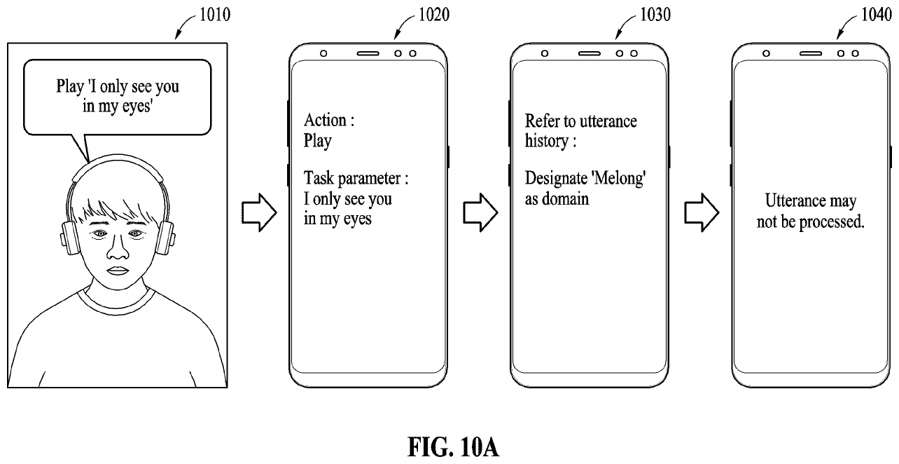

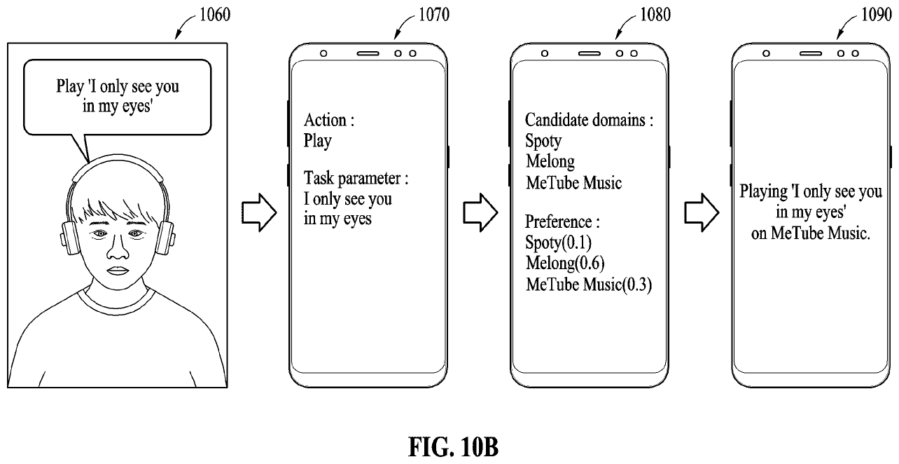

FIGS. 10A and 10B illustrate that the processor 520 of the intelligent server 200 differently processes a target utterance used to make a request to play music according to whether user history information according to a task parameter is used.

FIGS. 10A and 10B illustrate example embodiments, assuming that a ‘Melong’ application processed an utterance that is the same as the utterance of FIG. 7B and the application is a deleted application. An example embodiment of processing a target utterance “Play I only see you in my eyes” has been described with reference to FIG. 7B, and thus any repeated description related thereto has been omitted.

FIG. 10A illustrates that the processor processes the target utterance “Play I only see you in my eyes” without considering the user history information 560 corresponding to the task parameter described above with reference to FIG. 5.

Descriptions provided with reference to operations 760 and 770 of FIG. 7B are applicable to operations 1010 and 1020, and thus, detailed descriptions related thereto have been omitted.

In operation 1030, the processor 520 may not refer to the user history information 560 corresponding to the task parameter to designate a target domain. For example, when the processor 520 refers only to the utterance history DB 579 without considering the task parameter “I only see you in my eyes,” the ‘Melong’ application may be designated as the target domain based on information indicating that the same utterance was processed on the ‘Melong’ application.

When the processor 520 does not consider the user history information 560 corresponding to the task parameter, in operation 1040, a processing result that is not appropriate for a user intent may be generated. For example, as described above, in operation 1030, as the processor 520 does not consider the user history information corresponding to the task parameter, the ‘Melong’ application, which is a deleted application, may be designated as the target domain. Since there is no ‘Melong’ application on the electronic device 101, “The utterance may not be processed” that is not appropriate for the user intent may be generated as the processing result with respect to the target utterance “Play I only see you in my eyes” and transmitted to the electronic device 101.

FIG. 10B illustrates that the processor processes the target utterance “Play I only see you in my eyes” considering the user history information 560 corresponding to the task parameter described above with reference to FIG. 5.

An example embodiment to be described with reference to FIG. 10B may be similar to the example embodiment in which user history information is not used described above with reference to FIG. 10A, and thus, any repeated description related thereto has been omitted.

Descriptions provided with reference to operations 1010 and 1020 of FIG. 10A are applicable to operations 1060 and 1070, and thus, detailed descriptions related thereto have been omitted.

In operation 1080, as described above with reference to operation 780 of FIG. 7B, the processor 520 may determine candidate domains for processing the target utterance and calculate a user preference for each of the candidate domains with reference to the user log DB 540. For example, the processor 520 may determine that the candidate domains for processing the target utterance are the ‘Spoty’ application, ‘Melong’ application, and ‘MeTube Music’ application with reference to the capsule DB 230.

According to an example embodiment, in operation 1080, the processor 520 may calculate a user preference for each of the candidate domains with reference to the user log DB 540. The processor 520 may identify the user history information 560 corresponding the task parameter “I only see you in my eyes” in the user log DB 540 and calculate the user preference with reference to the domain information 563 corresponding to “I only see you in my eyes” and the information 567 on the number of times a corresponding domain is designated.

For example, when the processor 520 refers to the user history information 560 corresponding to the task parameter “I only see you in my eyes,” a value of a calculated preference for the ‘Melong’ application may be high based on ‘information indicating that ‘Melong’ is most, ‘MeTube Music’ is next, and ‘Spoty’ is least in terms of preferred application for a user who wants to play Korean music.’ Referring to FIG. 10B, preferences for the ‘Spoty,’ ‘Melong,’ and ‘MeTube Music’ applications may be calculated at 0.1, 0.6, and 0.3, respectively.

When the processor 520 considers the user history information 560 corresponding to the task parameter, in operation 1090, a target domain that is appropriate for the user intent may be designated. For example, because the ‘Melong’ application is deleted, the ‘MeTube Music’ application, which is the next domain in terms of preference, may be designated as the target domain, and “Play ‘I only see you in my eyes’ in the ‘MeTube Music’ application” may be generated as a processing result. The processing result may be transmitted to the electronic device 101.

Unlike the example embodiment described above with reference to FIG. 10A, in the example embodiment described with reference to FIG. 10B, a target domain is designated based on user history information for each task parameter such that a processing result that is appropriate for the user intent may be generated.

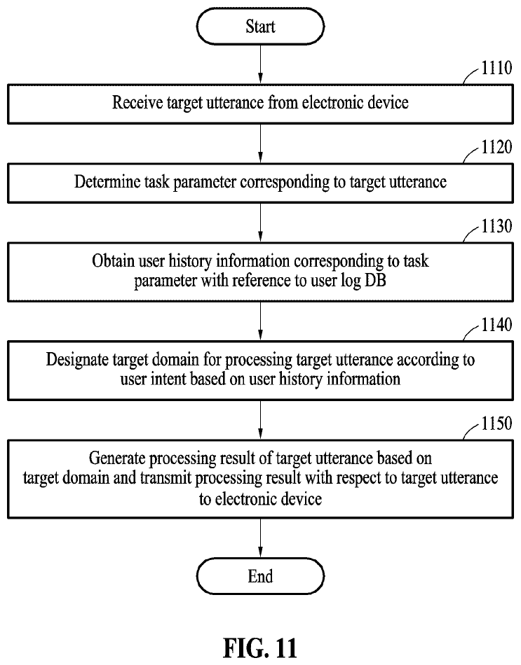

FIG. 11 is a flowchart illustrating an operation of the intelligent server 200 to process an utterance, according to an example embodiment.

Operations 1110 through 1150 may be performed by the processor 520 of the intelligent server 200 described above with reference to FIG. 5. Therefore, the description provided with reference to FIGS. 1 through 10B will not be repeated for conciseness.

In operation 1110, the processor 520 may receive a target utterance from the electronic device 101, which is one of client terminals for performing communication with the intelligent server 200. For example, as described with reference to FIG. 6A, the processor 520 may receive a target utterance “Order an American.”

In operation 1120, the processor 520 may determine a task parameter corresponding to the target utterance. For example, as described with reference to FIG. 6A, the processor 520 may determine that “an Americano” is the task parameter with respect to the target utterance “Order an American” with reference to the capsule DB 230.

In operation 1130, the processor 520 may obtain the user history information 560 corresponding to the task parameter with reference to the user log DB 540. For example, as described with reference to FIG. 6A, the processor 520 may obtain the user history information 560 corresponding to the task parameter “an American” of the target utterance “Order an American.” In the user history information 560 of the task parameter “an Americano” corresponding to account information of the electronic device 101, ‘information indicating that a ‘Star Coffee’ application has been designated as a target domain eight times’ and ‘information indicating that a ‘Coffee Bean’ application has been designated as a target domain two times’ may be included as the domain information 563 and the information 567 on the number of times.

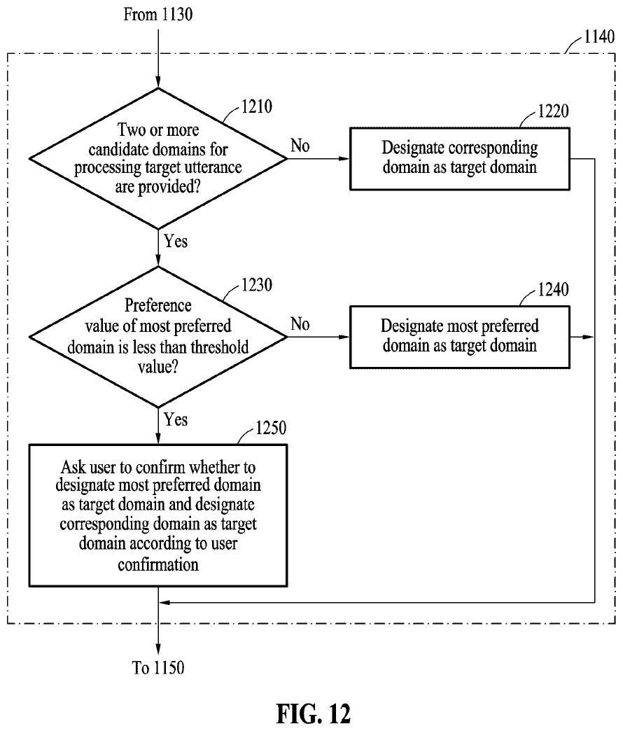

In operation 1140, the processor 520 may designate the target domain for processing the target utterance according to a user intent based on the user history information 560. For example, as described with reference to FIG. 6A, the processor 520 may designate the ‘Star Coffee’ application as the target domain with reference to the user history information 560 with respect to the task parameter “an Americano” of the target utterance “Order an Americano.” As described with reference to FIGS. 6A through 10B, when a plurality of candidate domains for processing a target utterance is provided, a target domain may be designated based on preference. An operation of the processor 520 to designate the target domain among the plurality of candidate domains is described in detail with reference to FIG. 12.

In operation 1150, the processor 520 may generate a result of processing the target utterance based on the target domain and transmit the result to the electronic device 101. For example, as described with reference to FIG. 6A, the processor 520 may generate “Order an Americano on the ‘Star Coffee’ application” as the result of processing the target utterance “Order an Americano” and transmit the result to the electronic device 101, which is a client terminal.

According to an example embodiment, operations similar to operations 1110 through 1160 may be performed by the processor 120 of the electronic device 101. As described with FIG. 5, on-device AI for processing a user utterance without communicating with the intelligent server 200 may be mounted on the electronic device 101. For example, a configuration of the on-device AI may be the same or similar to configurations of the natural platform 220 of the intelligent server 200 and the capsule DB 230. The processor 120 may receive the target utterance from a user, designate the target domain for processing the target utterance as described in operations 1120 through 1140, and process the target utterance based on the target domain. A configuration of the electronic device 101 on which the on-device AI is mounted is described in detail with reference to FIG. 13.

FIG. 12 is a flowchart illustrating an operation of the intelligent server 200 to process an utterance in response to a plurality of candidate domains being provided, according to an example embodiment.

Operations 1210 through 1250 may be performed by the processor 520 of the intelligent server 200 described above with reference to FIG. 5. Therefore, the description provided with reference to FIGS. 1 through 11 will not be repeated for conciseness.

Operations 1210 through 1250 may correspond to an operation (e.g., operation 1140 of FIG. 11), which is described with reference to FIG. 11, to designate a target domain based on user history information corresponding to a task parameter

In operation 1210, the processor 520 may determine whether two or more candidate domains for processing a target utterance are provided. For example, as described with reference to FIG. 6A, a number of candidate domains for processing the target utterance may be two or more, including ‘Star Coffee’ and ‘Coffee Bean’ applications. When there is one domain corresponding to the target utterance, in operation 1220, the processor 520 may designate the domain as a target domain.

In operation 1230, the processor 520 may determine whether a preference value of a most preferred domain is less than a threshold value. As described with reference to FIGS. 6A through 10B, the processor 520 may calculate a user preference for each candidate domain and compare a preference value for each candidate domain with a preset threshold value. For example, in response to a preference value of a most preferred domain being less than 0.5, it may be determined that the domain is not the most appropriate for a user intent. Accordingly, a user confirmation may be required to designate the domain as a target domain, as in operation 1250 to be described later.

In operation 1240, in response to the preference value of the most preferred domain being greater than or equal to the threshold value, the processor 520 may designate the most preferred domain as the target domain. For example, referring to FIG. 6A, the processor 520 may designate the ‘Star Coffee’ application, the most preferred domain, as the target domain because a preference value of the ‘Star Coffee’ application is 0.8, which is greater than 0.5.

In operation 1250, in response to the preference value of the most preferred domain being less than the threshold value, the processor 520 may ask a user to confirm whether to designate the most preferred domain among a plurality of candidate domains as the target domain and designate the domain as the target domain according to a user confirmation. For example, referring to FIG. 10B, because the ‘Melong’ application is deleted, the processor 520 may determine that the most preferred domain is the ‘MeTube Music’ application of which a preference value is 0.3 and that the user preference value is less than 0.5. Although not illustrated in FIG. 10B, the processor 520 may ask a user to confirm whether to play “I only see you in my eyes” on the ‘MeTube Music’ application and designate the ‘MeTube Music’ application as the target domain according to a user confirmation.

According to an example embodiment, as described with reference to FIG. 11, when the electronic device 101 includes on-device AI, operations similar to operations 1210 through 1250 may be performed by the processor 120 of the electronic device 101. A configuration of the electronic device 101 on which the on-device AI is mounted is described in detail with reference to FIG. 13.

FIG. 13 is a block diagram illustrating an operation of the electronic device 101 on which on-device AI is mounted, according to an example embodiment.

Referring to FIG. 13, the electronic device 101 and the intelligent server 200 may be the electronic device 101 and the intelligent server 200 described with reference to FIGS. 1 through 12. With respect to the electronic device 101 and the intelligent server 200, the descriptions provided with reference to FIGS. 1 through 12 are not repeated.

As described above with reference to FIGS. 2 through 4, the intelligent server 200 may include the natural language platform 220 including the ASR module 221, the NLU module 223, and TTS module 229. Although not illustrated in FIG. 13 for brevity, as described above with reference to FIG. 2, the natural language platform 220 may further include the planner module 225 and the NLG module 227, and the intelligent server 200 may further include the execution engine 240, the analytic platform 280, and the like. The capsule DB 230 may store a capsule in a form of the CAN 400 as described with reference to FIGS. 2 through 4.

According to an example embodiment, the electronic device 101 may include the client module 151 described with reference to FIG. 2, and an on-device AI module 1300 for processing a user utterance without communicating with the intelligent server 200 may be mounted on the electronic device 101. Although not illustrated in FIG. 11 for brevity, the electronic device 101 may further include at least some of the components described above with reference to FIGS. 1 and 5. For example, the processor 120 for performing operations same or similar to operations performed by the processor 520 described with reference to FIGS. 6A through 12 may be included in the electronic device 101.

According to an example embodiment, the on-device AI module 1300 may include a module for performing at least some functions of the components included in the intelligent server 200. For example, an embedded ASR (eASR) 1321 corresponding to the ASR 221 of the intelligent server, an embedded NLU (eNLU) 1323 corresponding to the NLU 223, an embedded TTS (eTTS) 1329 corresponding to the TTS 229, and an embedded capsule DB 1330 corresponding to the capsule DB 230 may be included in the on-device AI module 1330. The embedded capsule DB 1330, as the capsule DB 230, may store a capsule in the form of the CAN 400.

As described above with reference to FIG. 2, the processor 120 may receive a user utterance through the client module 151, and the user utterance may be transmitted to the intelligent server 200. In response to the on-device AI module 1300 being mounted on the electronic device 101, the processor 120 may recognize the user utterance based on the eASR 1321. The user utterance may be recognized through the ASR 221 of the intelligent server 200 when the user utterance may not be recognized with the eASR 1321.

In response to the user utterance being recognized with eASR 1321, an intent of the user utterance may be analyzed based on the eNLU 1323 and the embedded capsule DB 1330. The intent of the user utterance may be analyzed as described with reference to FIGS. 2 through 4. As described above with reference to FIGS. 6A through 12, the intent of the user utterance may be analyzed with reference to the user log DB 540. The intent of the user utterance may be analyzed through the NLU 223 and the capsule DB 230 of the intelligent server 200 when the intent of the user utterance may not be analyzed with the eNLU 1323 and the embedded capsule DB 1330.

In response to the intent of the user utterance being analyzed based on the eNLU 1323 and the embedded capsule DB 1330, a text is converted into a speech, and a result of processing the utterance may be output to the user.

According to an example embodiment, an intelligent server 200 configured to process a user utterance may include a communication module 590, comprising communication circuitry, configured to receive a target utterance from the electronic device 101 and transmit a result of processing the target utterance to the electronic device 101, a user log DB 540 configured to store user history information 560 corresponding to a task parameter, the task parameter being a parameter for performing an action according to a user intent, a memory 530 configured to store computer-executable instructions, and a processor 520 configured to execute the instructions by accessing the memory 530, wherein the instructions may be configured to determine the task parameter corresponding to the target utterance, obtain the user history information 560 corresponding to the task parameter with reference to the user log DB 540, designate a target domain for processing the target utterance according to a user intent based on the user history information 560, and generate the result of processing the target utterance based on the target domain.

According to an example embodiment, the task parameter may be determined based on information obtained to correspond to the target utterance or account information of the electronic device 101.

According to an example embodiment, the user history information 560 may include domain information 563 determined to correspond to the task parameter according to account information and information 567 on a number of times a domain is designated.

According to an example embodiment, the user history information 560 may be obtained based on a personal DB 573 configured to store personal information corresponding to account information, NES DB 576, and an utterance history DB 579 configured to store domain information history determined according to a user utterance.

According to an example embodiment, the user history information 560 may be learned based on deep learning according to account information.

According to an example embodiment, the personal information DB 573 may include at least one among installed application information corresponding to the account information, information of frequency of use of the application, contact information, account name information, and interworking device information, and the NES DB 576 may include metadata for a named entity.

Each embodiment herein may be used in combination with any other embodiment(s) described herein.

According to an example embodiment, the instructions may be configured to, in response to a plurality of candidate domains for processing the target utterance being provided, calculate a user preference for each of the plurality of candidate domains based on user history information 560 corresponding to the task parameter, and designate a most preferred domain among the plurality of candidate domains as the target domain

According to an example embodiment, the domain is software configured to process an utterance through the electronic device 101, and wherein the software may include at least one among an application, a program for providing a service in a form of a widget, and a web app.

According to an example embodiment, a method of processing a user utterance in an intelligent server 200 may include receiving 1110 a target utterance from an electronic device 101, determining 1120 a task parameter corresponding to the target utterance, the task parameter being a parameter for performing an action according to a user intent, obtaining 1130 user history information 560 corresponding to the task parameter, designating 1140 a target domain for processing the target utterance according to a user intent based on the user history information, and generating 1150 a result of processing the target utterance based on the target domain and transmitting the result of processing the target utterance to the electronic device 101.

According to an example embodiment, the task parameter may be determined based on information obtained to correspond to the target utterance or account information of the electronic device 101.

According to an example embodiment, the user history information 560 may include domain information 563 determined to correspond to the task parameter according to account information of the electronic device 101 and information 567 on a number of times the domain is designated.

According to an example embodiment, the user history information 560 may be obtained based on a personal DB 573 configured to store personal information corresponding to account information, NES DB 576, and an utterance history DB 579 configured to store domain information history determined according to a user utterance.

According to an example embodiment, the user history information 560 may be learned based on deep learning according to account information of the electronic device 101.

According to an example embodiment, the personal information DB 573 may include at least one among installed application information corresponding to the account information, information of frequency of use of the application, contact information, account name information, and interworking device information, and the NES DB 576 may include metadata for a named entity.

According to an example embodiment, the designating 1140 of the target domain may include, in response to a plurality of candidate domains for processing the target utterance being provided, calculating a user preference for each of the plurality of candidate domains based on the user history information 560, and designating a most preferred domain among the plurality of candidate domains as the target domain.

According to an example embodiment, the domain is software configured to process an utterance through the electronic device 101, and wherein the software may include at least one among an application, a program for providing a service in a form of a widget, and a web app.

According to an example embodiment, an electronic device 101 for processing a user utterance may include an input/output module 150, 155, comprising circuitry, configured to receive a target utterance from a user and output a result of processing the target utterance, a user log DB 540 configured to store user history information 560 corresponding to a task parameter, the task parameter being a parameter for performing an action according to a user intent, a memory 130 configured to store computer-executable instructions, and a processor 120 configured to execute the instructions by accessing the memory, wherein the instructions may be configured to determine the task parameter corresponding to the target utterance, obtain user history information 560 corresponding to the task parameter with reference to the user log DB 540, designate a target domain for processing the target utterance according to a user intent based on the user history information, and generate the result of processing the target utterance based on the target domain. “Based on” as used herein covers based at least on.

According to an example embodiment, the user history information 560 may include domain information 563 determined to correspond to the task parameter according to account information of the electronic device 101 and information 567 on a number of times the domain is designated to correspond to the task parameter.

According to an example embodiment, the user history information 560 may be obtained based on a personal information DB 573 configured to store personal information corresponding to account information of the electronic device, an NES DB 576, and an utterance history DB 579 configured to store domain information history determined according to a user utterance.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An intelligent server for processing a user utterance, the intelligent server comprising:
a communication module, comprising communication circuitry, configured to receive a target utterance from an electronic device and transmit a result of processing the target utterance to the electronic device;
a user log database (DB) configured to store user history information related to to a task parameter, the task parameter being a parameter for performing an action;
a memory configured to store computer-executable instructions; and a processor configured to execute the instructions by accessing the memory,
wherein the processor is configured to:
determine the task parameter corresponding to the target utterance;
obtain the user history information related to the task parameter with reference to the user log DB;
designate a target domain for processing the target utterance according to a user intent based on the user history information; and
generate the result of processing the target utterance based on the target domain.

2. The intelligent server of claim 1, wherein the task parameter based on information obtained to correspond to the target utterance and/or account information of the electronic device.

3. The intelligent server of claim 1, wherein the user history information comprises domain information based on the task parameter according to account information and information on a number of times the domain is designated.

4. The intelligent server of claim 1, wherein the user history information is based on a personal information DB configured to store personal information corresponding to account information, a named entity service (NES) DB, and an utterance history DB configured to store domain information history determined based on a user utterance.

5. The intelligent server of claim 1, wherein the user history information is learned based on deep learning based on account information.

6. The intelligent server of claim 4, wherein
the personal information DB comprises at least one of: installed application information corresponding to the account information, information of frequency of use of the application, contact information, account name information, and interworking device information, and
wherein the NES DB comprises metadata for a named entity.

7. The intelligent server of claim 1, wherein the processor is configured to, in response to a plurality of candidate domains for processing the target utterance being provided:
determine a user preference for each of the plurality of candidate domains based on user history information corresponding to the task parameter; and
designate a most preferred domain among the plurality of candidate domains as the target domain.

8. The intelligent server of claim 1, wherein the domain is configured to process an utterance through the electronic device, and comprises at least one among an application, a program for providing a service in a form of a widget, and a web app.

9. A method of processing a user utterance in an intelligent server, the method comprising:
receiving a target utterance from an electronic device;
determining a task parameter based on the target utterance, the task parameter being a parameter for performing an action;
obtaining user history information corresponding to the task parameter;
designating a target domain for processing the target utterance based on a user intent based on the user history information; and
generating a result of at least processing the target utterance based on the target domain and transmitting the result of processing the target utterance to the electronic device.

10. The method of claim 9, wherein the task parameter is determined based on information obtained to correspond to the target utterance and/or account information of the electronic device.

11. The method of claim 9, wherein the user history information comprises domain information determined to correspond to the task parameter according to account information of the electronic device and information on a number of times the domain is designated.

12. The method of claim 9, wherein the user history information is obtained based on a personal information database (DB) configured to store personal information corresponding to account information, a named entity service (NES) DB, and an utterance history DB configured to store domain information history determined according to a user utterance.

13. The method of claim 9, wherein the user history information is learned based on deep learning according to account information of the electronic device.

14. The method of claim 12, wherein
the personal information DB comprises at least one of: installed application information corresponding to the account information, information of frequency of use of the application, contact information, account name information, and interworking device information, and
the NES DB comprises metadata for a named entity.

15. The method of claim 9, wherein the designating of the target domain comprises, in response to a plurality of candidate domains for processing the target utterance being provided:
calculating a user preference for each of the plurality of candidate domains based on the user history information; and
designating a most preferred domain among the plurality of candidate domains as the target domain.

16. The method of claim 9, wherein the domain is configured to process an utterance through the electronic device, and comprises at least one among an application, a program for providing a service in a form of a widget, and a web app.

17. A non-transitory computer-readable storage medium storing instructions that, when executed by a processor, cause the processor to perform the method of claim 9.

18. An electronic device for processing a user utterance, the electronic device comprising:
an input/output module, comprising circuitry, configured to receive a target utterance from a user and output a result of processing the target utterance;
a user log database (DB) configured to store user history information corresponding to a task parameter, the task parameter being a parameter for performing an action according to a user intent;
a memory configured to store computer-executable instructions; and
a processor configured to execute the instructions by accessing the memory,
wherein the processor is configured to:
determine the task parameter corresponding to the target utterance;
obtain the user history information corresponding to the task parameter with reference to the user log DB;
designate a target domain for processing the target utterance according to a user intent based on the user history information; and
generate the result of processing the target utterance based on the target domain.

19. The electronic device of claim 18, wherein the user history information comprises domain information determined to correspond to the task parameter according to account information of the electronic device and information on a number of times the domain is designated to correspond to the task parameter.

20. The electronic device of claim 18, wherein the user history information is based on a personal information DB configured to store personal information corresponding to account information of the electronic device, a named entity service (NES) DB, and an utterance history DB configured to store domain information history determined according to a user utterance.
